(19) United States
(12) Patent Application Publication
(10) Pub. No.: US 2008/0037042 A1
(43) Pub. Date: Feb. 14, 2008

(54) IMAGE PROCESSING APPARATUS, AND IMAGE PROCESSING METHOD

(76) Inventors: Yoshinori FURUICHI, Kanagawa (JP); Tetsuo Asakawa, Tokyo (JP); Miki Kouchi, Kanagawa (JP); Akihiro Kakoi, Kanagawa (JP); Rie Nakamura, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/828,725

(22) Filed: Jul. 26, 2007

(30) Foreign Application Priority Data
Aug. 8, 2006 (JP) 2006-215752

(51) Int. Cl. H04N 1/00

(52) U.S. Cl. 358/1.6

(57) ABSTRACT

An image forming apparatus includes an information acquiring unit, a memory-capacity management unit, a setting change unit, an image processing unit, and an image memory. When a volume of image data stored in the image memory exceeds a threshold, the memory-capacity management unit interrupts the information acquiring unit from acquiring information on an image. The setting change unit changes setting conditions for image output to reduce a storage capacity required by image data in the image memory, and changes a condition of a setting item required to be changed along with the primary change. The image processing unit converts the image data stored in the image memory according to the changed setting conditions.

### CROSS-REFERENCE TO RELATED APPLICATIONS

The present application claims priority to and incorporates by reference the entire contents of Japanese priority document, 2006-215752 filed in Japan on Aug. 8, 2006.

### BACKGROUND OF THE INVENTION

1. Field of the Invention

The present invention relates to an image processing apparatus, and an image processing method.

2. Description of the Related Art

An image processing apparatus, such as a copier or a printer, has a function of storing therein a plurality of pieces of image data to be printed. By using the function, the image processing apparatus can output the image data in such a manner as combining a plurality of pages in a single page, sorting pages, and printing pages in inverse order.

An image processing apparatus, such as a scanner, also has a function of storing therein image data read from a material, and after having read all pages of the material, transmits or outputs the image data.

Because of such function, an image processing apparatus needs a large-capacity storage unit that can stores therein image data of required pages to be stored at once. However, a large-capacity storage unit is expensive, and therefore, it is difficult to equip a low-price image processing apparatus with a storage unit having sufficient capacity. For this reason, a low-price image forming apparatus has a problem on how to handle the case where image data of required pages cannot be stored.

To cope with such problem, for example, Japanese Patent Application Laid-open No. 2003-152955 discloses a conventional technology, in which an image reading device includes two kinds of storage media, namely, a compression memory and a one-page memory. Having read a material, the image reading device stores in the compression memory data compressed at a predetermined compression ratio, and in the one-page memory non-compression data. If a memory-full occurs in the compression memory, data is further compressed at a higher compression ratio, and then is stored in the compression memory again. Thus, reading operation can be continued.

However, the conventional technology has a problem that the two kinds of storage media increase cost, and is not suitably applied to a low-price image processing apparatus.

Moreover, the required number of pages of image data cannot always be stored in the compression memory only by changing the compression ratio. In this respect, particularly a device in a low price range, which cannot be equipped with a large-capacity storage media due to restriction on cost, is largely influenced.

### SUMMARY OF THE INVENTION

It is an object of the present invention to at least partially solve the problems in the conventional technology.

According to an aspect of the present invention, an image processing apparatus includes an image processing unit that converts input image to image data based on a condition of a first setting item specified to output an image, a storage unit that stores therein the image data, a control unit that interrupts receipt of input image when a volume of image data sorted in the storage unit exceeds a threshold, a setting unit that changes, when receipt of input image is interrupted, the condition of the first setting item to reduce a storage capacity required by image data in the storage unit, and automatically changes a condition of a second setting item required to be changed along with a change in the condition of the first setting item, and a converting unit that converts the image data stored in the storage unit according to the change in the condition of the first setting item.

According to another aspect of the present invention, an image processing apparatus includes an image processing unit that converts input image to image data based on a condition of a first setting item specified to output an image, a storage unit that stores therein the image data, a control unit that interrupts receipt of input image when a volume of image data sorted in the storage unit exceeds a threshold, a setting unit that changes, when receipt of input image is interrupted, the condition of the first setting item to reduce a storage capacity required by image data in the storage unit, and changes a condition of a second setting item required to be changed along with a change in the condition of the first setting item in response to an instruction received from a user, and a converting unit that converts the image data stored in the storage unit according to the change in the condition of the first setting item.

According to still another aspect of the present invention, an image processing method includes converting input image to image data based on a condition of a first setting item specified to output an image, storing the image data in a storage unit, interrupting receipt of input image when a volume of image data sorted in the storage unit exceeds a threshold, first changing, after the interrupting, the condition of the first setting item to reduce a storage capacity required by image data in the storage unit, second changing a condition of a second setting item required to be changed along with a change in the condition of the first setting item, and converting the image data stored in the storage unit according to the change in the condition of the first setting item.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a hardware configuration of an image forming apparatus according to an embodiment of the present invention;

FIG. 2 is a functional block diagram of the image forming apparatus;

FIG. 3 is a table that presents an example of setting changes performed by a setting change unit shown in FIG. 2;

FIG. 4 is a flowchart of processing performed by a CPU shown in FIG. 1 in response to a copy-start instruction;

FIGS. 5A and 5B are schematic diagrams for explaining relation between the capacity of an image memory and a memory-full detection threshold according to the embodiment;

FIG. 6 is a detailed flowchart of a secondary setting-change process shown in FIG. 4;

FIG. 7 is a flowchart of a secondary setting-change process according to a first modification of the embodiment;

FIG. 8 is an example of a screen for selecting a paper-feed tray according to the first modification;

FIG. 9 is an example of a screen for selecting a paper-ejection tray according to the first modification;

FIG. 10 is a flowchart of a secondary setting-change process according to a second modification of the embodiment;

FIG. 11 is an example of a screen for selecting an item according to the second modification;

FIG. 12 is an example of a screen for selecting a color mode according to the second modification; and

FIG. 13 is an example of a screen for selecting a resolution according to the second modification.

### DETAILED DESCRIPTION OF THE PREFERRED EMBODIMENTS

Exemplary embodiments of the present invention are explained in detail below with reference to the accompanying drawings.

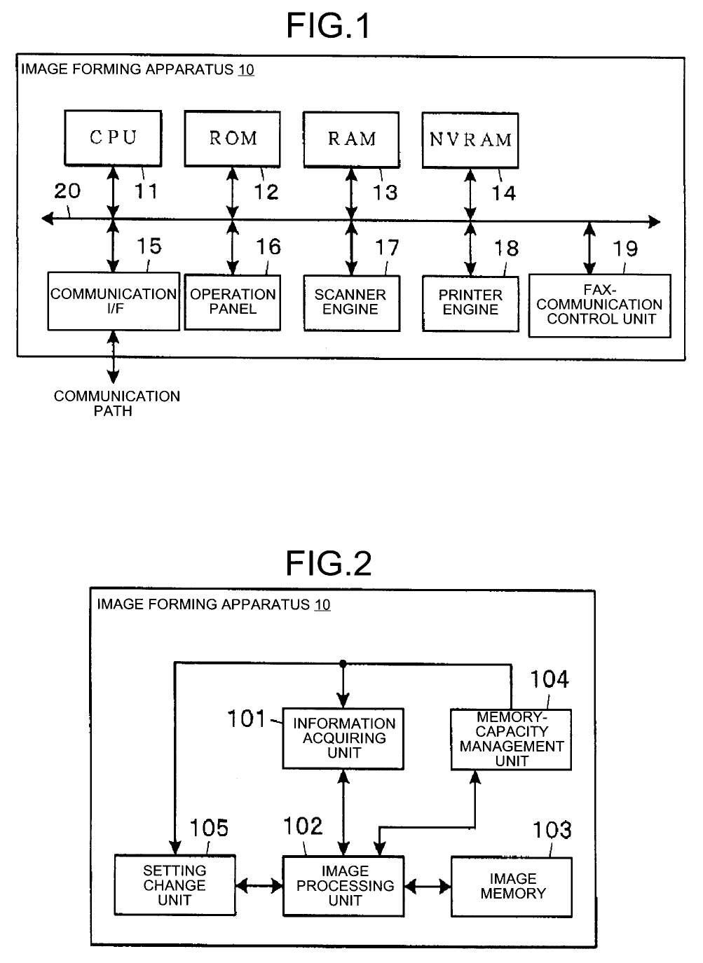

As shown in FIG. 1, an image forming apparatus 10 according to an embodiment of the present invention includes a central processing unit (CPU) 11, a read-only memory (ROM) 12, a random access memory (RAM) 13, a non-volatile memory (NVRAM) 14, a communication interface (I/F) 15, an operation panel 16, a scanner engine 17, a printer engine 18, and a facsimile (FAX)-communication control unit 19, all of which are connected to each other with a system bus 20.

The CPU 11 controls the image forming apparatus 10. The CPU 11 implements functions of scanning, printing, copying, facsimile communication, and the like, by executing various computer programs recorded on the ROM 12 or the NVRAM 14 and controlling each unit in the image forming apparatus 10. The CPU 11 also implements other functions related to features of the embodiment described later.

The ROM 12 is a non-volatile storage unit that stores therein a computer program to be executed by the CPU 11, static parameters, and the like. The ROM 12 can be configured as a rewritable storage unit on which such stored data can be updated.

The RAM 13 temporarily stores therein data to be used, and is used as a scratch-pad memory for the CPU 11. Part of the RAM 13 is used as an image memory for storing image data to be printed by the printer engine 18.

The NVRAM 14 is a non-volatile storage unit that is rewritable, such as a flash memory, and stores therein a computer program to be executed by the CPU 11, and parameters needed to be stored even after the image forming apparatus 10 is powered off. It is preferable that default values of parameters for respective setting items are stored in the NVRAM 14.

The communication I/F 15 is an interface to connect the image forming apparatus 10 to a communication path, such as a network. For example, the communication I/F 15 can be a network interface to perform Ethernet® communication in a wired or wireless manner. Alternatively, the communication I/F 15 can be an interface for local connection such as Institute of Electrical and Electronics Engineers (IEEE) 1284 interface, or a universal serial bus (USB). In addition, to perform facsimile communication via a public network, a network control unit (NCU) for connecting to the public network is provided.

The operation panel 16 includes a display unit made of a liquid crystal display (LCD) or a light emitting diode (LED), and an operation unit including various keys, buttons, touch panels laminated on a LCD, and the like. The display unit displays thereon an operational state of the image forming apparatus 10, setting conditions, a message, a graphical user interface (GUI) for receiving an operation, and the like. The operation unit receives an operation or an instruction to the image forming apparatus 10 by a user.

The scanner engine 17 is an image reading unit that reads an image of a material, and acquires image data from the read image. The scanner engine 17 includes an automatic document feeder (ADF). The image data acquired by reading is temporarily stored an image memory provided in the RAM 13. Then, the image data can be bit-mapped to be supplied to the printer engine 18 for printing the image data, or can be transmitted to an external device via the communication I/F 15.

The printer engine 18 is an image forming unit that forms or prints an image based on bit-mapped image data. The printer engine 18 can employs any of known methods, such as electphotography, LED method, or ink-jet method.

The FAX-communication control unit 19 has functions of performing control required for facsimile communication. Examples of the functions include encoding of image data to be transmitted, control on the NCU provided in the communication I/F 15, decoding of received image data, and storing of the image data in an image memory.

The image forming apparatus 10 is characterized by the operation which it performs when detecting that a volume of image data stored in the image memory exceeds a threshold, and that no more image data can be stored. This operation is mainly explained below.

As shown in FIG. 2, the image forming apparatus 10 includes an information acquiring unit 101, an image processing unit 102, an image memory 103, a memory-capacity management unit 104, and a setting change unit 105. Among the units, functions of the units other than the image memory 103 can be implemented by executing a certain control program by the CPU 11. The functions can also be implemented by using specialized hardware.

The information acquiring unit 101 acquires information as to contents of an image to be printed by the printer engine 18. The information acquiring unit 101 acquires such information, for example, through the scanner engine 17 that reads an image of a material, or externally receiving the information via the communication I/F 15.

The image processing unit 102 converts the information acquired by the information acquiring unit 101 into image data. The printer engine 18 forms an image of contents of the image data based on setting items specifying a print mode, such as picture quality, resolution, color mode, two-sided, combination, zoom rate, sorting, and background elimination. The image processing unit 102 then causes the image memory 103 to store therein the image data. The setting items for specifying a print mode are first setting items, and conditions of the setting items are stored in the image forming apparatus 10. However, the conditions can be supplied from an external device along with the information acquired by the information acquiring unit 101. When causing the image memory 103 to store therein image data, preferably, the image processing unit 102 compresses the image data.

If a modification of image data is required along with change in setting conditions, the image processing unit 102 reads out image data temporarily stored in the image memory 103, modifies the image data to image data appropriate to the changed setting conditions by performing required image processing, and again causes the image memory 103 to store therein the modified image data. In this case, the image processing unit 102 functions as a converting unit.

The image memory 103 is of a predetermined capacity reserved in the RAM 13, and is used for storage of image data.

The memory-capacity management unit 104 is a control unit that monitors a volume of image data stored in the image memory 103. If the volume exceeds a predetermined threshold, the memory-capacity management unit 104 determines that the image memory 103 can be written with no more image data due to memory-full, and interrupts the information acquiring unit 101 acquiring information. If the information is to be acquired from the scanner engine 17, the memory-capacity management unit 104 interrupts scanning. If, for example, the information is to be externally acquired via the communication I/F 15, the memory-capacity management unit 104 requests a transmission interruption to a source.

Moreover, when interrupting acquisition of information, the memory-capacity management unit 104 instructs the setting change unit 105 to change settings to reduce a storage capacity (area) of the image memory 103 required for storing image data.

The setting change unit 105 changes conditions of setting items for specifying a print mode to reduce a storage capacity of the image memory 103 required for storing image data according to an instruction from the memory-capacity management unit 104, and causes the image processing unit 102 to modifies image data stored in the image memory 103 to image data appropriate to the changed setting conditions. Moreover, when changing conditions of setting items for specifying a print mode, the setting change unit 105 changes a condition of another setting item required to be changed along with the change.

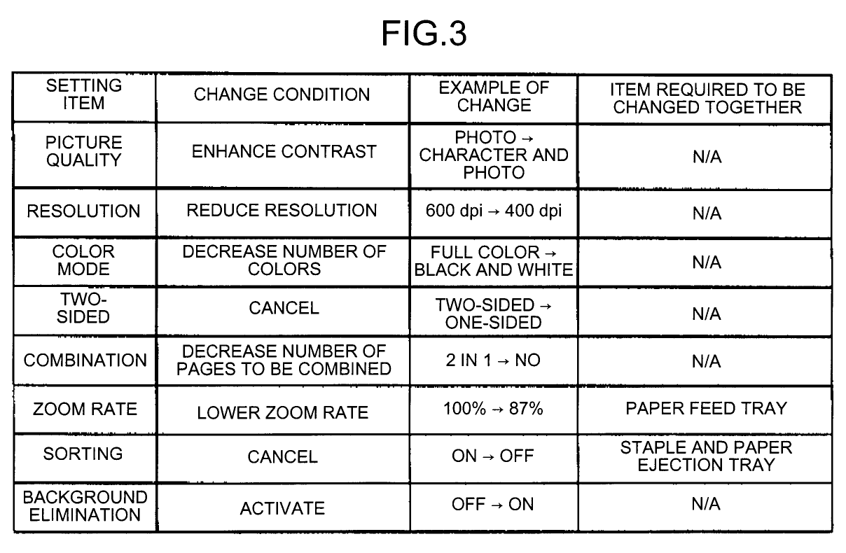

An example of setting changes performed by the setting change unit 105 is shown in FIG. 3.

Setting items to be changed by the setting change unit 105 are setting items for specifying a print mode, and include, for example, picture quality, resolution, color mode, two-sided, combination, zoom rate, sorting, and background elimination.

Conditions of setting items is changed for reducing an image-data volume per page, or reducing the number of pages required to be stored in the image memory.

For example, as the setting change unit 105 changes the picture quality to enhance contrast, a change rate in gradation turns to steep, whereby compression efficiency can be improved. As the setting change unit 105 activates the background elimination, compression efficiency can be improved by making background areas completely white.

As the setting change unit 105 reduces the resolution and the number of colors, a dot count per page and a bit count per dot are reduced, whereby a data volume per page can be reduced. As the setting change unit 105 reduces the zoom rate, an image size is decreased, and a dot count per page is also reduced, whereby a data volume per page can be reduced.

As the setting change unit 105 cancels the two-sided printing and the sorting, or reduces the number pages to be combined, the number of pages of image data required to be stored in an image memory for forming an image can be reduced. Particularly, if the sorting is selected (ON), image data of all pages needs to be stored in the image memory. However, if the sorting is not used (OFF), data of a page of which printing of the required number of copies is finished can be deleted, so that printing can be carried out if an image memory can store therein image data of at least one page.

It is preferable to set in advance which one of the setting items is to be preferentially changed.

When a condition of one setting item is changed, sometimes a condition of another item needs to be changed along with the change. Such items are presented in a column of “item required to be changed together” shown in FIG. 3.

For example, when the setting change unit 105 changes the zoom rate, if a size of paper to be used for printing remains unchanged, a blank is created. Therefore, it is preferable that the setting change unit 105 select a size of paper appropriate to the changed zoom rate by changing the paper-feed tray. Moreover, when the setting change unit 105 cancels the sorting, it would be inconvenient if stapling is carried out. Therefore, it is preferable that the setting change unit 105 additionally cancel the stapling. When the stapling is canceled, a finisher is not to be used. Therefore, it is preferable that the setting change unit 105 change the paper-ejection tray appropriately.

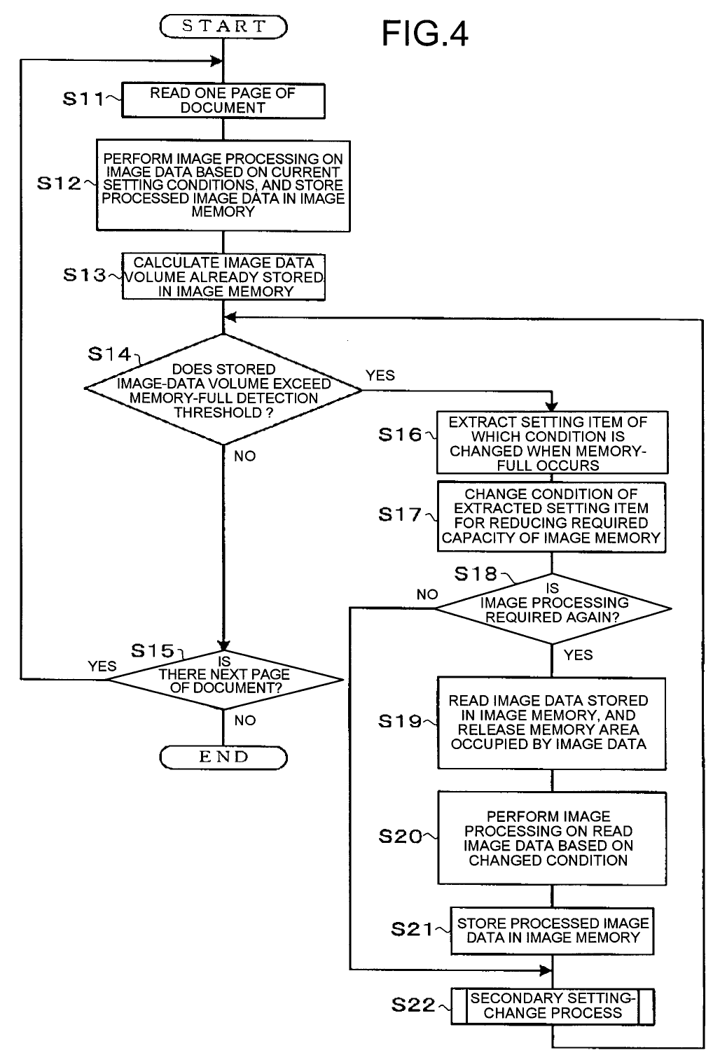

Processing performed by the CPU 11 is explained below with reference to FIG. 4. The CPU 11 starts the processing in response to a copy-start instruction after a material document is placed on the ADF.

In the processing, to begin with, the CPU 11 activates the scanner engine 17, causes the scanner engine 17 to read one page of the material document at step S11, and acquires image data representing contents of the material document. At step S12, the CPU 11 performs image processing on the image data based on setting conditions currently specified on the image forming apparatus 10 to obtain image data appropriate to the setting conditions, and stores the processed image data in the image memory 103.

At step S13, the CPU 11 calculates a volume of image data already stored in the image memory 103. At step S14, the CPU 11 determines whether the stored image-data volume exceeds a memory-full detection threshold. Here, the stored image-data volume does not include a volume of image data that is read out and deleted from the image memory 103 to be used for image forming or to be re-processed along with the setting change.

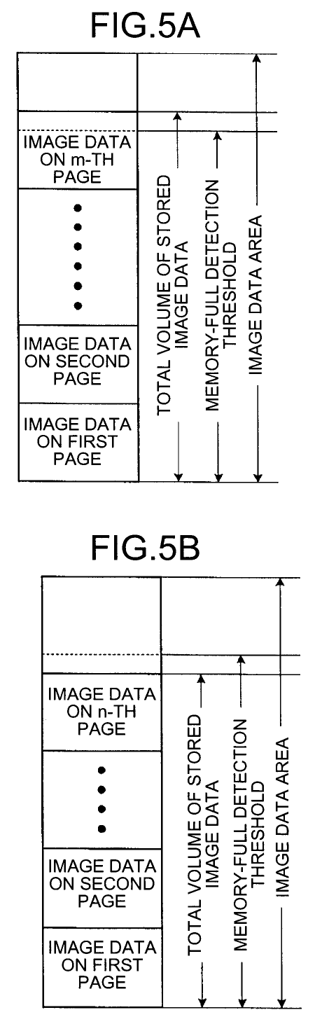

Relation between the capacity of the image memory 103 and the memory-full detection threshold is shown in FIG. 5.

As described above, in the image forming apparatus 10, a partial area in the RAM 13 is used as the image memory 103. The memory-full detection threshold is set to a value less than the storage capacity of the image-memory area by a little more than an image-data volume of one page. If an image-data volume stored in the image memory 103 exceeds the memory-full detection threshold, the image memory 103 is determined to be at the memory-full state where image data of the next page may not be stored in the image memory 103.

FIG. 5A presents a state where the image memory 103 is at the memory-full. FIG. 5B presents a state where the image memory 103 is not at the memory-full. It is expected that an image-data volume per page varies depending on setting conditions, such as resolution, color, and the like, or contents of the document material when data compression is performed. Therefore, the memory-full detection threshold can be dynamically determined based on a data volume of pages that are already stored. The method of determining the memory-full detection threshold is not limited to the above method.

Returning to the explanation of FIG. 4, if the stored image-data volume does not exceed the memory-full detection threshold at step S14, the CPU 11 determines that image data of the next page can be stored in the image memory 103, and determines whether there is a next page of the material document at step S15. If there is a next page, the process control goes back to step S11, and repeats the processing. If there is no next page, the processing is terminated.

Processing related to transmission and printing of the read image is performed at an appropriate timing separately from the processing shown in FIG. 4.

By contrast, if the stored image-data volume exceeds the memory-full detection threshold at step S14, the CPU 11 determines that there is a possibility that image data of the next page cannot be stored in the image memory 103. The process control goes to step S16, and the CPU 11 extracts a setting item of which condition is changed when the memory-full occurs. At step S17, the CPU 11 changes condition of the extracted setting item such that a required capacity of the image memory 103 is reduced. A concrete example of conditions to be changed is as explained with reference to FIG. 3. When any condition is changed at step S17, the changed setting condition is used afterwards in the processing at step S12.

After step S17, the process control goes to step S18, and the CPU 11 determines whether image processing is required again on the image data stored in the image memory 103 along with the change in the setting condition. If the image processing is required, the CPU 11 reads out the image data stored in the image memory 103, and releases a memory area occupied by the image data at step S19. At step S20, the CPU 11 performs the image processing on the read image data based on the setting condition changed at step S17, and stores the processed image data in the image memory 103 at step S21.

Specifically, if the zoom rate is changed, for example, from 100% to 87% at step S17, the CPU 11 once reads out the image data stored in the image memory 103 as data having a dot count corresponding to the zoom rate 100%. The CPU 11 converts the read image data into image data having a dot count corresponding to the zoom rate 87% by performing zoom-out operation, and stores the converted image data in the image memory 103 again. The processing can be performed by dividing the material document by a page, or by a certain number of lines, as required.

After step S21, the process control goes to a secondary setting-change process at step S22. The secondary setting-change process is a process of changing a condition of a setting item required to be changed along with a setting condition change at step S17.

If image processing is not required at step S18, the process control directly goes to step S22.

After step S22, the process control goes to step S14 and repeats the processing.

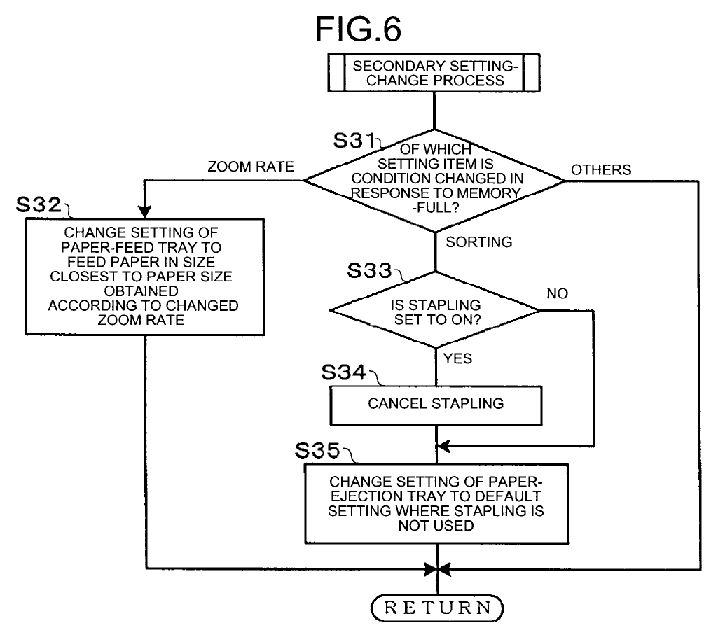

FIG. 6 is a flowchart of the secondary setting-change process shown at step S22 in FIG. 4. It is assumed in FIG. 6 that there are options of the setting items as shown in FIG. 3 that can be changed at steps S16 and S17.

In the secondary setting-change process, at step S31, the CPU 11 determines of which setting item a condition has been changed at step S17 in response to the memory-full.

If the changed setting item is the zoom rate, the process control goes to step S32, and the CPU 11 changes the currently selected paper-feed tray to the one that feeds paper in a size closest to a paper size obtained according to the changed zoom rate, and the process control goes back to the primary process. For example, when a material document in size A3 is read to be printed on A3 paper at a zoom rate of 100%, a paper-feed tray for A3 paper is selected. If the zoom rate is changed to 71% at step S17, an image size to be formed changes to A4, and the paper-feed tray is changed to another tray that feeds A4 paper. If a suitable paper-feed tray is not available, the paper-feed tray can remain unchanged.

If the changed setting item is the sorting at step S31, the process control goes to step S33, and the CPU 11 determines whether stapling is set to be performed (ON). If stapling is set to ON, the CPU 11 cancels it at step S34.

The process control then goes to step S35, the CPU 11 changes the setting of the paper-ejection tray to a default setting where the stapling is not applied. For example, the CPU 11 changes the setting to use a main tray, and then goes back to the primary process.

If the changed setting item is other than the above items at step S31, the CPU 11 determines that there is no item to be changed in the secondary setting-change process, and the process control directly goes back to the primary process.

If a memory-full occurs, the image forming apparatus 10 can reduce a storage capacity (area) required in the image memory 103 by automatically changing the settings by performing the processes shown in FIGS. 4 and 6. Accordingly, the image forming apparatus 10 can perform printing or data transmission by effectively using the image memory 103 even if the image memory 103 has a small storage capacity. If the memory-full does not occur, for example, if the quantity of pages is few, the image memory 103 can store therein image data having a large data volume per page, thereby being highly convenient for the user.

A setting item that needs to be changed along with the setting change for reducing a required storage capacity can be automatically changed into an appropriate condition by the process shown in FIG. 6. Accordingly, an appropriate operation can be performed without bothering a user, so that a function related to an efficient use of the image memory 103 can be improved.

Incidentally, a setting item needed to be changed along with the setting condition change at step S17 is not necessarily specified in advance. For example, the image forming apparatus 10 can be configured to, in the secondary setting-change process, scan conditions of all the setting items regardless of the condition of a change performed at step S17, screen out items in which an impracticable condition or an inappropriate condition under the changed state is set, and change the condition of the screened out item to an appropriate one.

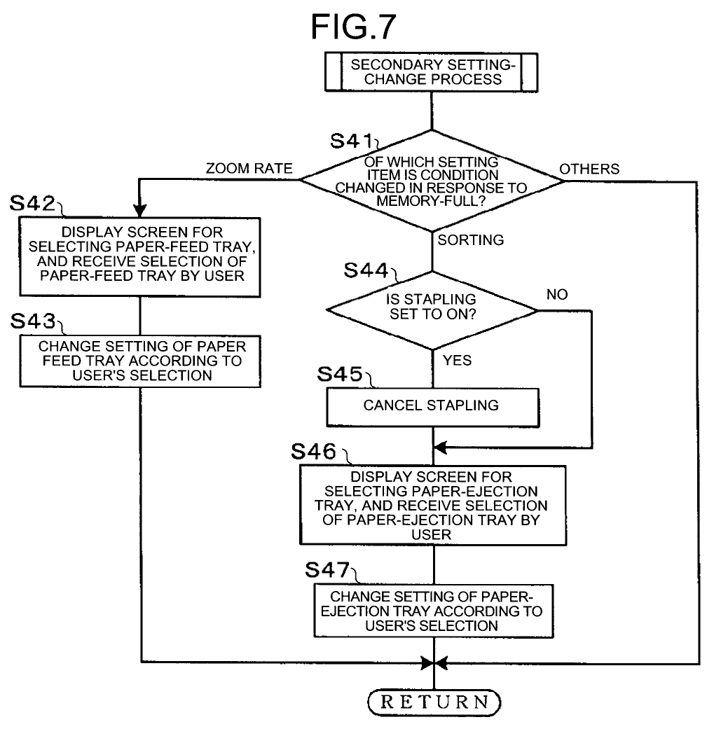

A first modification of the above embodiment is explained below. The first modification differs from the above embodiment only in details of the secondary setting-change process shown in FIG. 6. Therefore, only a secondary setting-change process according to the first modification is explained with reference to FIG. 7.

In the secondary setting-change process according to the first modification, at step S41, the CPU 11 also determines of which setting item a condition is changed at step S17 in response to the memory-full.

If the changed setting item is the zoom rate, the CPU 11 determines that the setting of the paper-feed tray needs to be changed along with the change at step S17. The process control then goes to step S42, and the operation panel 16 displays thereon a screen for selecting a paper-feed tray, and receives selection of a paper-feed tray by a user.

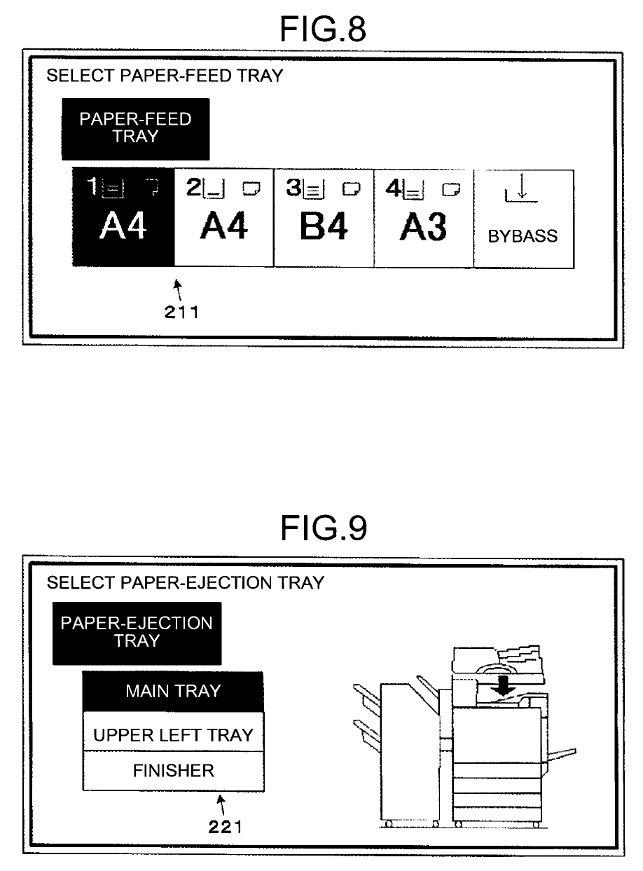

An example of a screen for selecting a paper-feed tray is shown in FIG. 8. On the screen, the user can select a paper-feed tray to be used for feeding paper with a paper-feed tray selecting button 211. The currently selected paper-feed tray is indicated on the screen by displaying the button in an inverse manner. The user selects a paper-feed tray, and then presses a continuation button (not shown). Accordingly the process shown in FIG. 7 can be continued. The paper-feed tray can remain unchanged.

Returning to explanation of FIG. 7, at step S43, the CPU 11 changes the setting of the paper-feed tray according to the user's selection, and then goes back to the primary process.

If the changed setting item is the sorting at step S41, the process control goes to step S44, and the CPU 11 determines whether the stapling is set to be performed (ON). If the stapling is set to ON, the CPU 11 cancels it at step S45.

The process control then goes to step S46, the operation panel 16 displays thereon a screen for selecting a paper-ejection tray, and receives selection of a paper-ejection tray by the user.

An example of a screen for selecting a paper-ejection tray is shown in FIG. 9. On the screen, the user can select a paper-ejection tray to be used for ejecting paper with a paper-ejection tray selecting button 221. The currently selected paper-ejection tray is indicated on the screen by displaying the button in an inverse manner. The user selects a paper-ejection tray, and then presses the continuation button (not shown). Accordingly the process shown in FIG. 7 can be continued. The paper-ejection tray can remain unchanged.

Returning to explanation of FIG. 7, at step S47, the CPU 11 changes the setting of the paper-ejection tray according to the user's selection, and then goes back to the primary process.

If the changed setting item is other than the above items at step S41, the CPU 11 determines that there is no item to be changed in the secondary setting-change process, and the process control directly goes back to the primary process.

In the image forming apparatus 10, if there is an setting item needed to be changed along with a setting change for reducing a storage capacity required in the image memory 103 at the time of memory-full, a user can select a condition to be set for the setting item by performing the processing shown in FIG. 7. Thus, the condition of the setting item can be set according to the user's selection, and operation can be carried out as desired by the user. As a result, a function for an efficient use of the image memory 103 can be improved.

The cancellation of the use of stapling at step S45 is also automatically carried out in the process shown in FIG. 7, because a significant inconvenience may occur if the setting condition is maintained, and a changed setting condition can be uniquely determined.

Upon display of the screen shown in FIG. 8 or 9, it is preferable that the operation panel 16 displays thereon details of the setting change carried out for reducing a storage capacity required in the image memory 103.

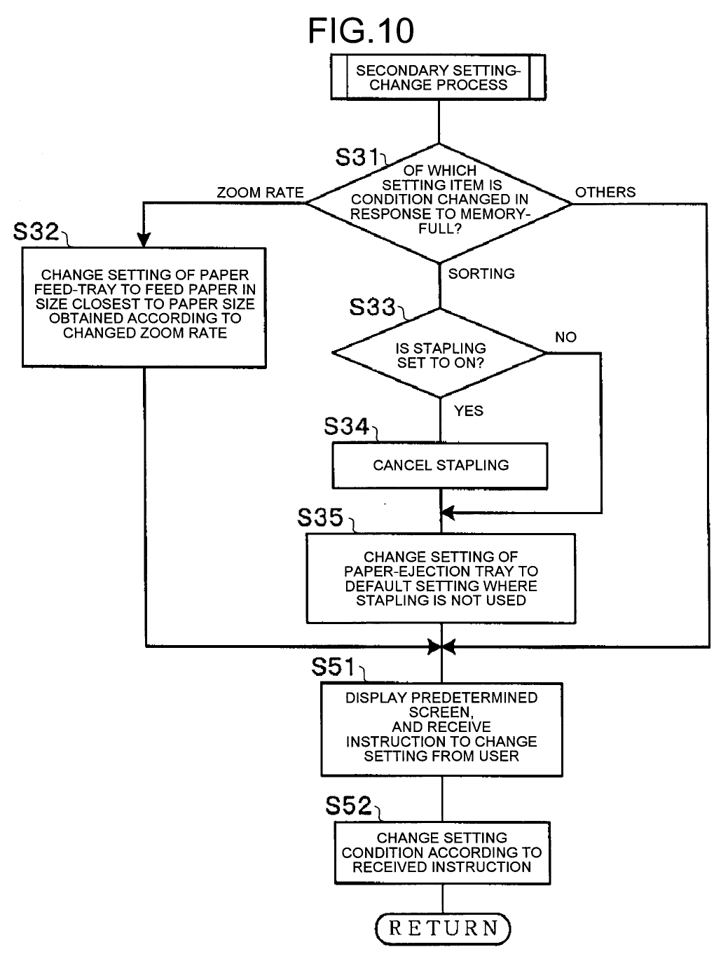

A second modification of the above embodiment is explained below. The second modification also differs from the above embodiment only in details of the secondary setting-change process shown in FIG. 6. Therefore, only a secondary setting-change process according to the second modification is explained with reference to FIG. 10.

The process according to the second modification differs from the process shown in FIG. 6 only in steps S51 and S51 after step S31 or S35.

At step S51, the operation panel 16 displays thereon a predetermined screen, and receives an instruction to change settings from a user. At step S52, the CPU 11 changes the setting conditions of the image forming apparatus 10 according to the received instruction, and the process control goes back to the primary process. Any condition of a setting change can be received at step S51 as required.

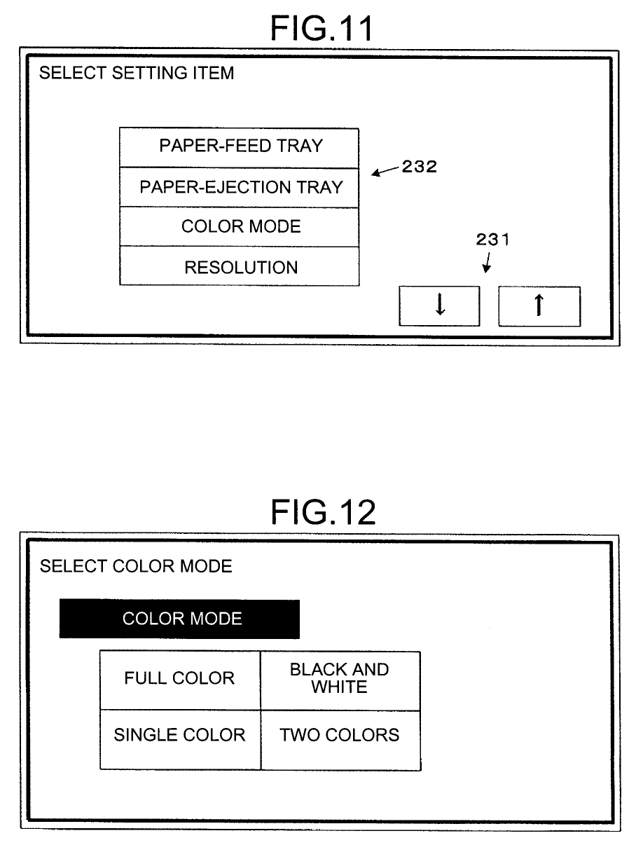

An example of a screen for receiving a setting change displayed in the processing at step S51 is shown in FIG. 11.

The screen is used for selecting a setting item to change a condition thereof. A user can select a setting item as required with a cursor key 231 from those displayed in an item list 232. FIG. 11 depicts a state where no item is selected. If any of the setting items is selected, the screen indicates that the item is selected by displaying the selected item in an inverse manner in the item list 232. As the user selects any of the setting items and presses the continuation button (not shown), the screen shifts to the one for setting a condition of the selected setting item.

FIG. 11 depicts an example of a screen on which the items of the paper-feed tray, the paper-ejection tray, the color mode, and the resolution can be selected. If the paper-feed tray or the paper-ejection tray is selected on the screen, the screen shifts to one of the screens shown in FIG. 8 or 9.

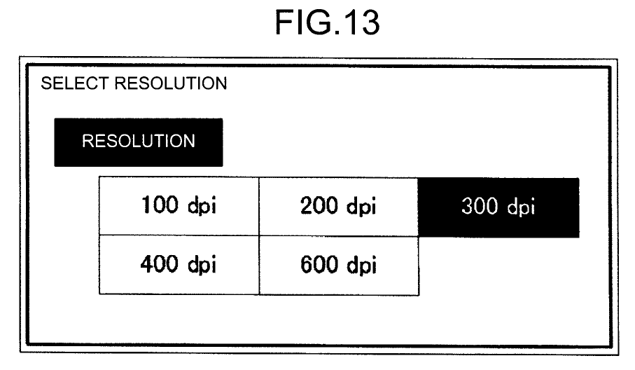

If the color mode or the resolution is selected, a condition of the setting items can be selected on the respective screen shown in FIG. 12 or FIG. 13.

In the image forming apparatus 10, if a setting change for reducing a storage capacity required in the image memory 103 is carried out at the time of memory-full, a user can select a setting item related to the changed setting item to change a condition thereof by performing the process shown in FIG. 10. Accordingly, operation can be carried out as desired by the user, and a function for an efficient use of the image memory 103 can be improved.

Upon display of the screen shown in FIG. 11, it is preferable that the operation panel 16 displays thereon details of the setting change carried out for reducing a storage capacity required in the image memory 103.

The embodiments and the modifications are susceptible to several variations and modifications. For example, the image processing apparatus can be a scanner without printer engine that transmits image data acquired by reading a material to the outside, or a printer without scanner engine that performs printing based on image data received from the outside.

Moreover, the image processing apparatus can receive information on an image to be printed as data described in a printer language, and acquires image data to be used for printing by performing drawing processing based on the received data. A method of forming an image is not limited to printing, but can be any method capable of forming an image based on image data on a certain medium, such as exposure on photographic paper or film.

The embodiments and the modifications described above can be implemented in any combination as appropriate.

According to an embodiments of the present invention, an image processing apparatus has a function of changing settings for an output image depending on its operating state so that a storage unit can store therein image data effectively. Moreover, the use of such a function can be facilitated for users.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image processing unit that converts input image to image data based on a condition of a first setting item specified to output an image;
a storage unit that stores therein the image data;
a control unit that interrupts receipt of input image when a volume of image data sorted in the storage unit exceeds a threshold;
a setting unit that changes, when receipt of input image is interrupted, the condition of the first setting item to reduce a storage capacity required by image data in the storage unit, and automatically changes a condition of a second setting item required to be changed along with a change in the condition of the first setting item; and
a converting unit that converts the image data stored in the storage unit according to the change in the condition of the first setting item.

2. The image processing apparatus according to claim 1, wherein the first setting item specifies a paper size, and the second setting item specifies a feed tray.

3. The image processing apparatus according to claim 1, wherein the first setting item specifies necessity of sorting, and the second setting item specifies an ejection tray.

4. The image processing apparatus according to claim 1, wherein the setting unit receives, upon changing the condition of the first setting item, an instruction from a user to change a condition of a third setting item, and changes the condition of the third setting item in response to the instruction.

5. An image processing apparatus comprising:
an image processing unit that converts input image to image data based on a condition of a first setting item specified to output an image;
a storage unit that stores therein the image data;
a control unit that interrupts receipt of input image when a volume of image data sorted in the storage unit exceeds a threshold;
a setting unit that changes, when receipt of input image is interrupted, the condition of the first setting item to reduce a storage capacity required by image data in the storage unit, and changes a condition of a second setting item required to be changed along with a change in the condition of the first setting item in response to an instruction received from a user; and
a converting unit that converts the image data stored in the storage unit according to the change in the condition of the first setting item.

6. The image processing apparatus according to claim 5, wherein the first setting item specifies a paper size, and the second setting item specifies a feed tray.

7. The image processing apparatus according to claim 5, wherein the first setting item specifies necessity of sorting, and the second setting item specifies an ejection tray.

8. An image processing method comprising:
converting input image to image data based on a condition of a first setting item specified to output an image;
storing the image data in a storage unit;
interrupting receipt of input image when a volume of image data sorted in the storage unit exceeds a threshold;
first changing, after the interrupting, the condition of the first setting item to reduce a storage capacity required by image data in the storage unit;
second changing a condition of a second setting item required to be changed along with a change in the condition of the first setting item; and
converting the image data stored in the storage unit according to the change in the condition of the first setting item.

9. the image processing method according to claim 8, wherein the second changing includes receiving an instruction from a user to change the condition of the second setting item, and changing the condition of the second setting item in response to the instruction.

10. The image processing method according to claim 8, wherein the first setting item specifies a paper size, and the second setting item specifies a feed tray.

11. The image processing method according to claim 8, wherein the first setting item specifies necessity of sorting, and the second setting item specifies an ejection tray.

12. The image processing apparatus according to claim 8, further comprising:
receiving an instruction from a user to change a condition of a third setting item; and
third changing the condition of the third setting item in response to the instruction.
